(19) United States
(12) Patent Application Publication
(10) Pub. No.: US 2023/0175868 A1
(43) Pub. Date: Jun. 8, 2023

(54) APPARATUS FOR SENSING ROTATING DEVICE

(71) Applicant: SAMSUNG ELECTRO-MECHANICS CO., LTD., Suwon-si (KR)

(72) Inventors: Si Young KWON, Suwon-si (KR); Yong Wook KIM, Suwon-si (KR)

(73) Assignee: SAMSUNG ELECTRO-MECHANICS CO., LTD., Suwon-si (KR)

(21) Appl. No.: 17/719,562

(22) Filed: Apr. 13, 2022

(30) Foreign Application Priority Data
Dec. 6, 2021 (KR) 10-2021-0173006

(51) Int. Cl. G01D 5/22; G01B 7/30

(52) U.S. Cl. CPC G01D 5/225; G01B 7/30

(57) ABSTRACT

An apparatus for sensing a rotating body includes a rotating body including a detection target portion; a pattern portion disposed in the detection target portion in a direction in which the rotating body rotates; a frame that rotatably supports the rotating body; a first sensor disposed to oppose a first region of the detection target portion; a second sensor spaced apart from the first sensor and disposed to oppose a second region of the detection target portion; and a holder portion coupled to the frame to hold the first sensor and the second sensor.

### CROSS-REFERENCE TO RELATED APPLICATION(S)

This application claims the benefit under 35 USC 119(a) of Korean Patent Application No. 10-2021-0173006 filed on Dec. 6, 2021 In the Korean Intellectual Property Office, the entire disclosure of which is incorporated herein by reference for all purposes.

### BACKGROUND

### 1. Field

The following description relates to an apparatus for sensing a rotating body.

### 2. Description of the Background

In general, there is increasing market demand for digital watches for interacting with mobile phones. A digital crown, having an exterior similar to an exterior of a crown of an analog watch, is being applied to a digital watch, a high-tech digital device.

A digital crown is used to select a function of a digital watch as an input/output (I/O) component of the digital watch and to generate an input signal to perform the selected function.

Selecting and performing a function using a digital crown are performed by a rotation operation and a pressing operation (a translation operation) of the crown. A representative method of selecting a menu is a method of irradiating light to a shaft connected to a crown and then analyzing the type of reflected light to detect rotation, and is implemented using a spring and a switch. The digital crown may sense a rotational angle of a crown and may provide minute displacement to a set such as a watch, or the like, to implement functions required by the set.

A rotating body, including the digital crown and the shaft described above, is applied to various fields such as a motor and a wheel switch of a wearable device required to be miniaturized and slimmed. According to such a tendency, a sensor detecting a rotational angle of a rotating body is required to have a technology for detecting minute displacement of the rotating body and to have a miniaturization technology for reducing a space occupied by a sensing structure.

In addition, desired characteristics may be obtained by implementing a digital crown module sensing a rotational angle of a crown and providing minute displacement to a set such as a watch to implement functions required by the set.

However, apparatuses for sensing a rotating body according to the related art suffer from a characteristic deviation therebetween caused by a deviation at the time of assembling constituent structures. For example, apparatuses for sensing a rotating body may suffer from a waveform deviation caused by an assembly variation of structures thereof.

The above information is presented as background information only, to assist in gaining an understanding of the present disclosure. No determination has been made, and no assertion is made, as to whether any of the above might be applicable as prior art with regard to the disclosure.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an apparatus for sensing a rotating body includes a rotating body including a detection target portion; a pattern portion disposed in the detection target portion in a direction in which the rotating body rotates; a frame that rotatably supports the rotating body; a first sensor disposed to oppose a first region of the detection target portion; a second sensor spaced apart from the first sensor and disposed to oppose a second region of the detection target portion; and a holder portion coupled to the frame to hold the first sensor and the second sensor.

In another general aspect, an apparatus for sensing a rotating body includes a rotating body including a detection target portion; a pattern portion disposed in the detection target portion in a direction in which the rotating body rotates, and having a single band shape surrounding the detection target portion; a frame into which the rotating body is inserted; a first sensor disposed to oppose a first region of the detection target portion; a second sensor disposed to oppose a second region of the detection target portion and spaced apart from the first sensor to form an angle; and a holder portion coupled to the frame to support the first sensor and the second sensor.

The apparatus may include a substrate on which the first sensor and the second sensor are disposed, the substrate may have a plurality of holes, and the holder portion may include a plurality of projections configured to be inserted into and coupled to the plurality of holes of the substrate.

The frame may include opposite side body portions, and each of the opposite side body portions may have a through-hole into which the rotating body is inserted. The frame may also include a plurality of legs disposed between the opposite side body portions in an axial direction of the rotating body in the vicinity of the rotating body inserted into the through-holes.

Each of the opposite side body portions of the frame may include a plurality of projections configured to be coupled to the holder portion, the holder portion may include a plurality of grooves disposed in positions, respectively corresponding to the plurality of projections of the opposite side body portions of the frame, and the plurality of projections of the opposite side body portions of the frame may be configured to be inserted into the plurality of grooves of the holder portion.

The holder portion may include a plurality of projections configured to be in contact with the opposite side body portions of the frame when the holder portion is coupled to the opposite side body portions of the frame, each of the opposite side body portions may include a plurality of through-portions configured to be in contact with the holder portion, and the plurality of projections of the holder portion may be configured to be inserted into and coupled to the plurality of through-portions of the opposite side body portions of the frame.

The frame may include a step disposed between a first portion, coupled to the substrate, and a second portion to which the holder portion is coupled.

The apparatus may include a coupling ring disposed between the through-hole of one of the opposite side body portions of the frame and the rotating body such that the rotating body is rotatably and closely coupled to the respective through-hole of the frame.

The substrate may be a flexible printed circuit board (FPCB), and the first sensor and the second sensor may be disposed between the plurality of legs of the frame.

Other features and aspects will be apparent from the following detailed description, the drawings, and the claims.

### BRIEF DESCRIPTION OF DRAWINGS

FIG. 1 is a view illustrating an example of an apparatus for sensing a rotating body.

FIG. 2 is an exploded perspective view of the apparatus for sensing a rotating body illustrated in FIG. 1.

FIG. 3 is a view illustrating an example of a rotating body.

FIG. 4 is a view illustrating an example of a structure of a frame.

FIG. 5 is a view illustrating an example of arrangement of a substrate, first and second sensors, and a holder portion.

FIG. 6A is a view illustrating an example of a separated state of the substrate and the holder portion.

FIG. 6B is a view illustrating an example of a coupled state of the substrate and the holder portion.

FIG. 7A is a view illustrating an example of a separated state of the frame and the holder portion.

FIG. 7B is a view illustrating a first example of a separated state of the frame and the holder portion.

FIG. 8A is a view illustrating an example of a separated state of the frame and the holder portion.

FIG. 8B is a view illustrating a second example of a separated state of the frame and the holder portion.

FIG. 9 is a view illustrating an example of a step of a frame for coupling the substrate and the holder portion.

FIG. 10A is a view illustrating an example of a separated state of a rotating body having a coupling ring and the frame.

FIG. 10B is a view illustrating an example of a separated state of the rotating body having the coupling ring and the frame.

FIG. 11 is a view illustrating an example of a first sensor and a second sensor.

FIG. 12 is a view illustrating an example of an arrangement relationship of the rotating body, the first sensor, and the second sensor.

FIG. 13A is a graph of an impedance change signal of the first and second sensors when the holder portion is not employed.

FIG. 13B is a graph of an impedance change signal of the first and second sensors when the holder portion is employed.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

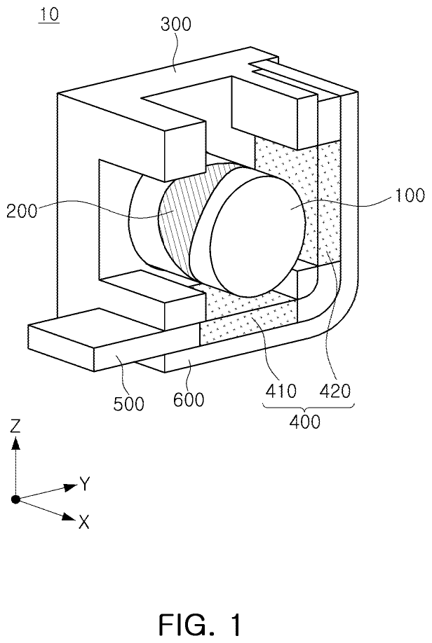

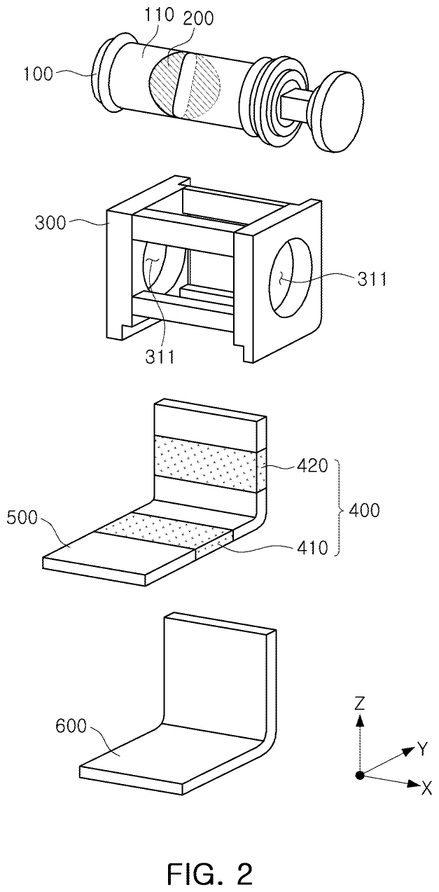

FIG. 1 is a view illustrating an example of an apparatus for sensing a rotating body, and FIG. 2 is an exploded perspective view of the apparatus for sensing a rotating body illustrated in FIG. 1.

Referring to FIGS. 1 and 2, an apparatus 10 for sensing a rotating body may include a rotating body 100, a pattern portion 200, a frame 300, a sensor portion 400 including a first sensor 410 and a second sensor 420, and a holder portion 600.

The rotating body 100 may be disposed of a non-conductive material, and the sensor portion 400 may include a detection target portion 110 to detect rotation of the rotating body 100.

The pattern portion 200 may be disposed of a conductive material, and may be disposed in the detection target portion 110 in a direction in which the rotating body 100 rotates. For example, the pattern portion 200 may have a shape of a single band surrounding the detection target portion 110.

The frame 300 may be disposed of a non-conductive material, and may have a through-hole 311 into which the rotating body 100 is inserted. The rotating body 100 may be rotatably inserted into the through-hole 311.

The first sensor 410 may be disposed to oppose one region of the detection target portion 110, and may detect the rotation of the rotating body 100.

The second sensor 420 may be spaced apart from the first sensor 410 and disposed to oppose the other region of the detection target portion 110, and may detect the rotation of the rotating body 100. As an example, the second sensor 420 may be spaced apart from the first sensor 410 to form a predetermined angle with respect to the first sensor 410.

The holder portion 600 may be coupled to the frame 300 as described below to reduce a deviation of a detection signal caused by a manufacturing deviation or an assembly deviation, and thus, the first sensor 410 and the second sensor 420 may be securely held.

For example, when one surface of each of the first and second sensors 410 and 420 is a sensing surface and a surface opposing the sensing surface is the other surface, the holder portion 600 may be disposed on the other surface of each of the first and second sensors 410 and 420, and may be mechanically coupled to the frame 300 as described below to securely fix the first sensor 410 and the second sensor 420. Such a description may be applied to each example discussed herein.

As an example, the apparatus 10 for sensing a rotating body may include a substrate 500.

The first sensor 410 and the second sensor 420 may be disposed at the substrate 500. As an example, the first sensor 410 and the second sensor 420 may be disposed on an upper surface of the substrate 500 and/or in the substrate 500.

The first sensor 410 and the second sensor 420 may be disposed on the substrate 500 as a printed pattern and may securely hold the substrate 500 with the holder portion 600 to reduce a structural assembly deviation or a manufacturing deviation.

As an example, the holder portion 600 may be disposed to securely hold the substrate 500 on which the first sensor 410 and the second sensor 420 are disposed. To this end, the holder 600 may be supported by an internal structure of the device for sensing a rotating body.

In each drawing discussed herein, unnecessary overlapping descriptions in relation to the same reference numeral and the same function will not be provided, and mainly differences among the examples in the diagrams will be described.

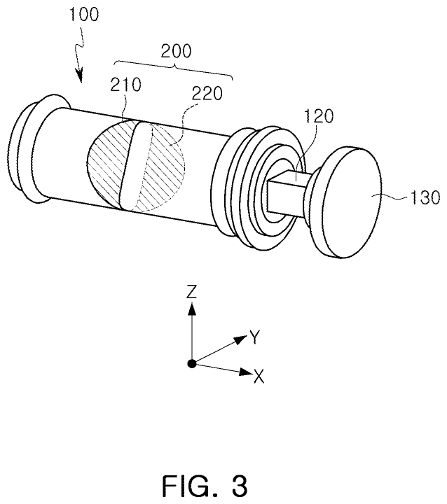

FIG. 3 is a view illustrating an example of a rotating body.

Referring to FIG. 3, the rotating body 100 may include the detection target portion 110, a rotating shaft 120, and a rotation applying portion 130.

For example, the detection target portion 110 may be a rotation member provided on one end of the rotating body 100 and may have a cylindrical shape, but the configuration is not limited thereto. The rotation applying portion 130 is a digital crown provided on the other end of the rotating body 100 and may have a round shape, but the configuration is not limited thereto. The pattern portion 200 may be provided on a side surface of the detected target portion 110.

The rotation shaft 120 may be provided between the rotation applying unit 130 and the detection target portion 110.

For example, when a user of an electronic device, to which the apparatus 10 for sensing a rotating body is applied, rotates the rotation applying portion 130 in a clockwise or counterclockwise direction, the rotation shaft 120 connected to the rotation applying portion 130 may also rotate together in the same direction and at the same speed. Since the entire rotating body 100 rotates together as the rotation shaft 120 rotates, the detection target portion 110 provided on one end of the rotating body 100 may also rotate in the same direction and at the same speed. For example, as illustrated in FIG. 3, the pattern portion 200 may have a shape of a single band surrounding the detection target portion 110 and may include a first pattern portion 210 and a second pattern portion 220 having different widths. For example, the first pattern portion 210 may have a width greater than an average width, and the second pattern portion 220 may have a width smaller than the average width.

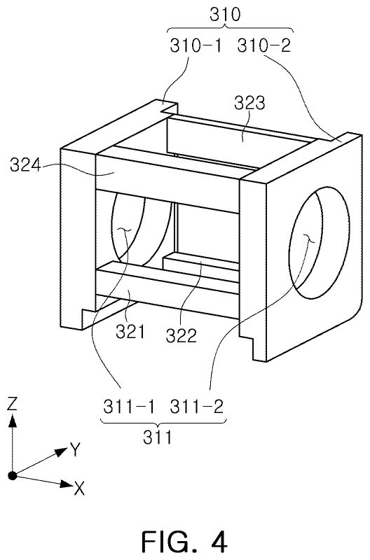

FIG. 4 is a view illustrating an example of a structure of a frame.

Referring to FIG. 4, the frame 300 may include opposite side body portions 310 and a plurality of legs 321, 322, 323, and 324.

The opposite side body portions 310 may include two body portions including a first body portion 310-1 and a second body portion 310-2. The first and second body portions 310-1 and 310-2 may have through-holes 311 (311-1 and 311-2) into which the rotating body 100 is rotatably inserted, respectively. As an example, the rotating body 100 may be inserted into the through-holes 311-1 and 311-2 to rotate.

The plurality of legs 321, 322, 323, and 324 may be disposed between the opposite side body portions 310 in an axial direction of the rotating body 100 in the periphery of the rotating body 100 inserted into the through-hole 311. For example, as illustrated in FIG. 4, the plurality of legs 321, 322, 323, and 324 may be disposed in the axial direction of the rotating body 100 in a state of being spaced apart from each other between the first body portion 310-1 and the second body portion 310-2.

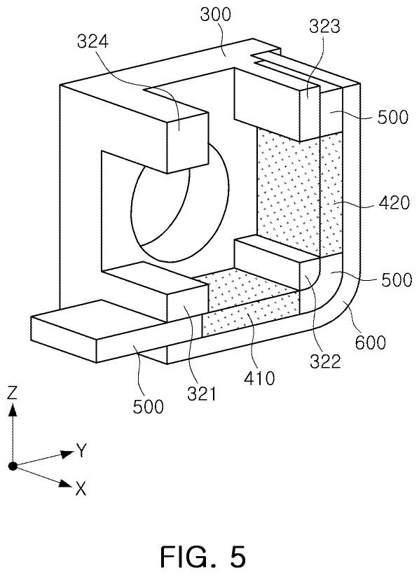

FIG. 5 is a view illustrating an example of arrangement of the substrate 500, the first and second sensors 410 and 420, and the holder portion 600.

Referring to FIG. 5, for example, the substrate 500 may be disposed of a flexible printed circuit board (FPCB). As illustrated in FIG. 5, the substrate 500 may be securely attached to the plurality of legs 321, 322, 323, and 324 of the frame 300.

As an example, the first sensor 410 may be disposed in the substrate 500 and may be disposed between the two legs 321 and 322, among the plurality of legs 321, 322, 323, and 324 of the frame 300, to oppose one region of the pattern portion 200, disposed in the detection target portion 110, so as to detect rotation of the rotating body 100.

The second sensor 420 may be disposed on the substrate 500 and may be disposed between two legs 322 and 323, among the plurality of legs 321, 322, 323, and 324 of the frame 300, to oppose another region of the pattern portion 200, disposed in the detection target portion 110, so as to detect the rotation of the rotating body 100.

As an example, the first sensor 410 and the second sensor 420 may be inductive sensors detecting an inductance change depending on an electromagnetic interaction with the pattern portion 200.

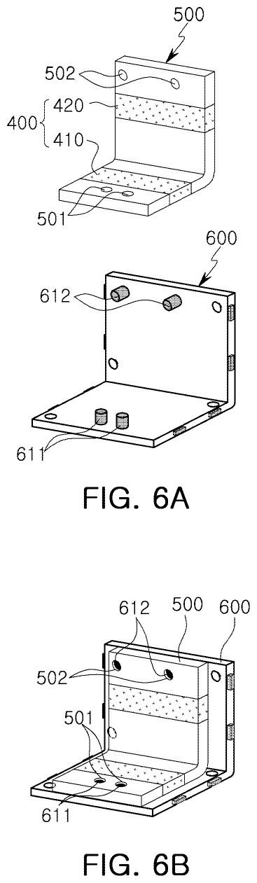

FIG. 6A is a view illustrating an example of a separated state of the substrate and the holder portion, and FIG. 6B is a view illustrating an example of a coupled state of the substrate and the holder portion.

Referring to FIG. 6A, the substrate 500 may include a plurality of holes 501 and 502 to be tightly coupled to the holder portion 600, and the holder portion 600 may include a plurality of projections 611 and 612 disposed in positions, corresponding to a plurality of holes 501 and 502 of the substrate 500, to be fitted into the plurality of holes 501 and 502.

Referring to FIG. 6B, the plurality of projections 611 and 612 of the holder portion 600 may be fitted and inserted into the plurality of holes 501 and 502 of the substrate 500, and thus, the substrate 500 and the holder portion 600 may be securely coupled to each other.

For example, each of the plurality of holes 501 and 502 and the plurality of projections 611 and 612 may be disposed in a position which does not interfere with the first sensor 410 and the second sensor 420. In addition, since the layout illustrated in FIGS. 6A and 6B are only an example, the position is not limited to a specific position.

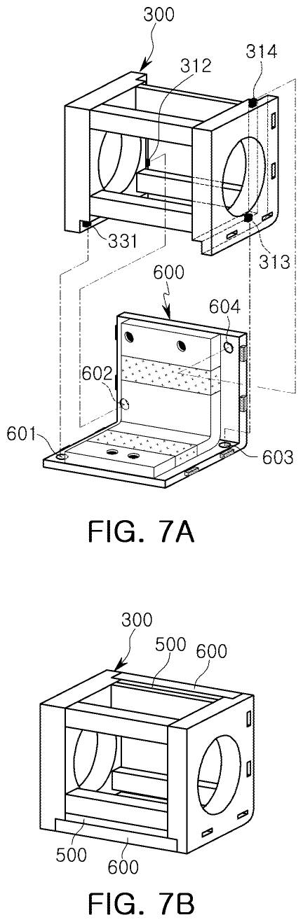

FIG. 7A is a view illustrating an example of a separated state of the frame and the holder portion, and FIG. 7B is a view illustrating a first example of a separated state of the frame and the holder portion.

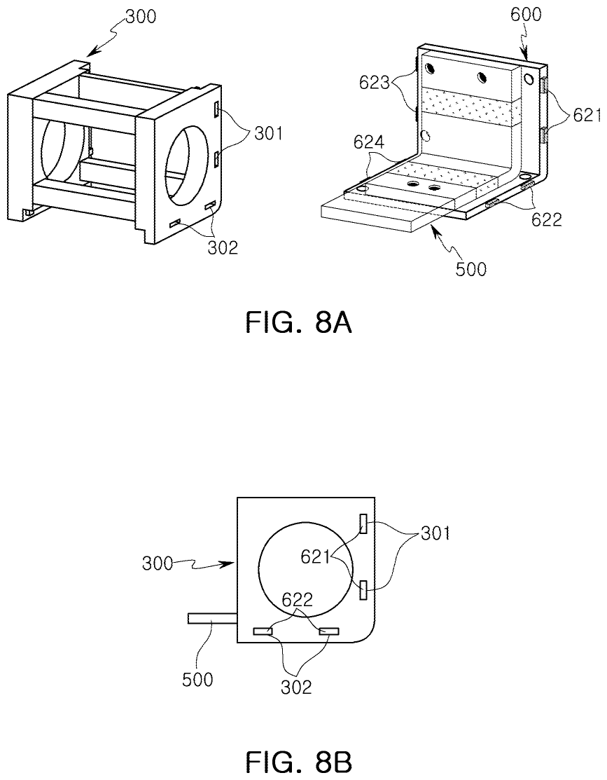

FIG. 8A is a view illustrating an example of a separated state of the frame and the holder portion, and FIG. 8B is a view illustrating a second example of a separated state of the frame and the holder portion.

Referring to FIG. 7A, opposite side body portions 310 and 320 of the frame 300 may include a plurality of projections 331, 312, 313, and 314 disposed in positions in contact with the holder 600 to be coupled to the holder portion 600.

The holder portion 600 may have a plurality of grooves 601, 602, 603, and 604 disposed in positions, respectively corresponding to the plurality of projections 331, 312, 313, and 314 of the opposite side body portions 310 and 320 of the frame 300.

Referring to FIG. 7B, the plurality of projections 331, 312, 313, 314 of the frame 300 may be fitted and inserted into the plurality of grooves 601, 602, 603, 604 of the holder portion 600, so that they may be securely coupled to each other.

Referring to FIG. 8A, the holder portion 600 may include a plurality of projections 621, 622, 623, and 624 disposed in positions in contact with the opposite side body portions 310 of the frame 300.

The opposite side body portions 310 of the frame 300 may include a plurality of through-portions 301 and 302 disposed in positions with which the holder portion 600 is in contact.

Referring to FIG. 8B, the projections 621 and 622 of the holder portion 600 may be fitted and inserted into the through-portions 301 and 302 of the opposite side body portion 310 of the frame 300, so that the holder portion 600 and the frame 300 may be securely coupled to each other. Also, the projections 623 and 624 of the holder portion 600 may be fitted and inserted into through-portions (not illustrated) of the other opposite side body portion 310 of the frame 300.

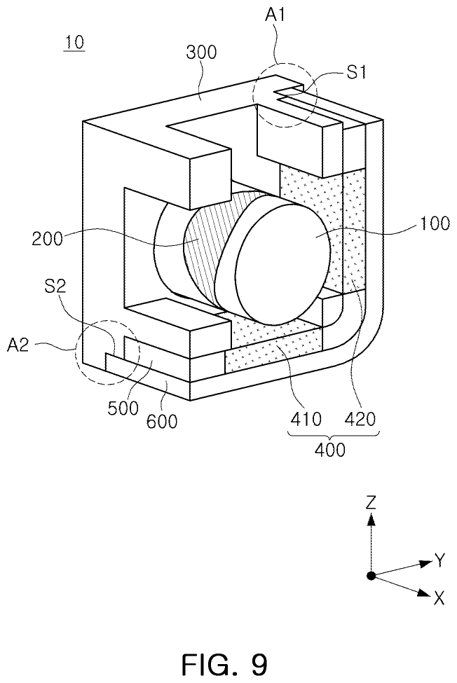

FIG. 9 is a view illustrating an example of a step of a frame for coupling the substrate and the holder portion.

Referring to FIG. 9, the frame 300 may have steps S1 and S2 disposed between a portion, coupled to the substrate 500, and a portion, to which the holder portion 600 is coupled, as illustrated in A1 and A2 of FIG. 9.

Accordingly, the substrate 500 and the holder portion 600 may be accurately coupled to the frame 300 in a predetermined position by the steps S1 and S2.

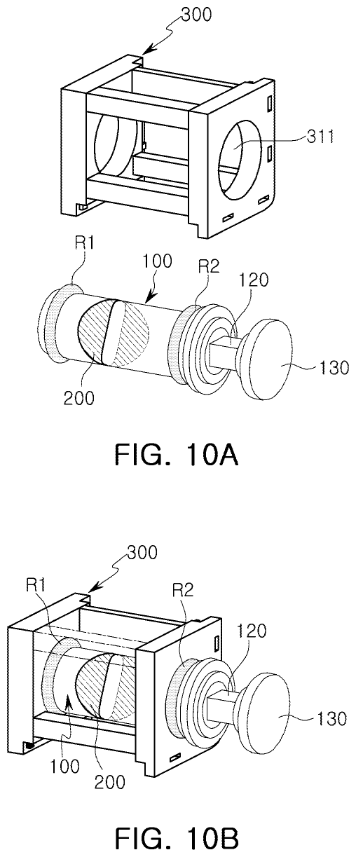

FIG. 10A is a view illustrating an example of a separated state of a rotating body having a coupling ring and the frame, and FIG. 10B is a view illustrating an example of a separated state of the rotating body having the coupling ring and the frame.

Referring to FIGS. 10A and 10B, the apparatus 10 for sensing a rotating body may include coupling rings R1 and R2 disposed between the through-hole 311 of the frame 300 and the rotating body 100 such that the rotating body 100 is rotatably and closely coupled to the through-hole 311 of the frame 300.

For example, the coupling rings R1 and R2 may be disposed of silicon, and may provide appropriate friction and tension between the frame 300 and the rotating body 100 to maintain appropriate frictional force during a rotation motion and a translation motion of the rotating body 100. Referring to FIG. 10A, the frame 300 and the rotating body 100 may be tightly coupled to each other to expect a waterproof effect.

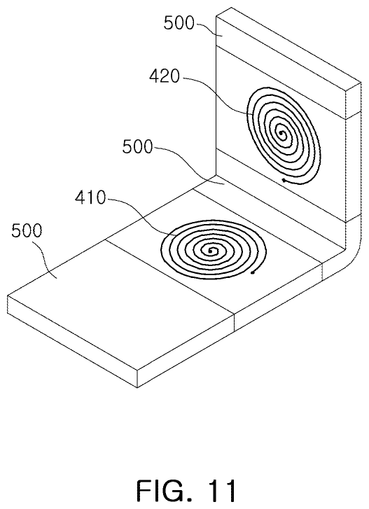

FIG. 11 is a view illustrating an example of a first sensor and a second sensor.

Referring to FIG. 11, the first sensor 410 and the second sensor 420 may be, for example, sensing coils disposed on the substrate 500 as a printed pattern, but the configuration is not limited thereto.

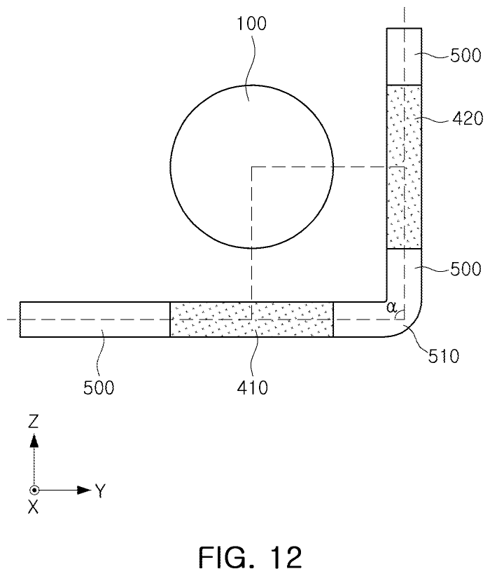

FIG. 12 is a view illustrating an example of an arrangement relationship of the rotating body, the first sensor, and the second sensor.

Referring to FIG. 12, the substrate 500 may include a bent portion 510 bent such that the first and second sensors 410 and 420 have a predetermined angle with respect to a central portion of the rotating body 100.

For example, a predetermined angle (an angle a of FIG. 12) disposed between the sensing surface of the first sensor 410 and the sensing surface of the second sensor 420 may vary and may correspond to 90 degree, as an example.

The angle a may be determined depending on a shape of the pattern portion 200 disposed in the detection target portion 110. For example, the shape of the pattern portion 200 corresponding to the positions of the first sensor 410 and the second sensor 420 may be changed as the rotating body 100 rotates. The angle α, disposed by the sensing surfaces of the first and second sensors 410 and 420, may be determined depending on a change period of the shape.

Referring to FIGS. 3 and 12, the first sensor 410 and the second sensor 420 may be disposed such that the sensing surfaces thereof form a predetermined angle α. As an example, the shape of the pattern portion 200 corresponding to the position of the first sensor 410 and the shape of the pattern portion 20 corresponding to the position of the second sensor 420 may be different from each other.

For example, when the first sensor 410 is disposed in a position adjacent to the first pattern portion 210, the second sensor 420 may be disposed in a position adjacent to the second pattern portion 220. In this case, when the detection target portion 110 rotates clockwise, a width of the pattern portion 200 corresponding to the position of the first sensor 410 may be changed and a width of the pattern portion 200 corresponding to the position of the second sensor 420 may also be changed. As the widths of the pattern portions 200 opposing the first sensor 410 and the second sensor 420 are changed as described above, inductances detected in the first and second sensors 410 and 420 may also be changed.

Referring to FIG. 12, each of the first sensor 410 and the second sensor 420 may detect an inductance change signal as the rotating body 100 rotates. For example, each of the inductance change signal may have a predetermined phase difference depending on an arrangement relationship of the first sensor 410 and the second sensor 420.

As an example, the inductance change signals detected by the first sensor 410 and the second sensor 420 may represent a sine function or a cosine function, respectively.

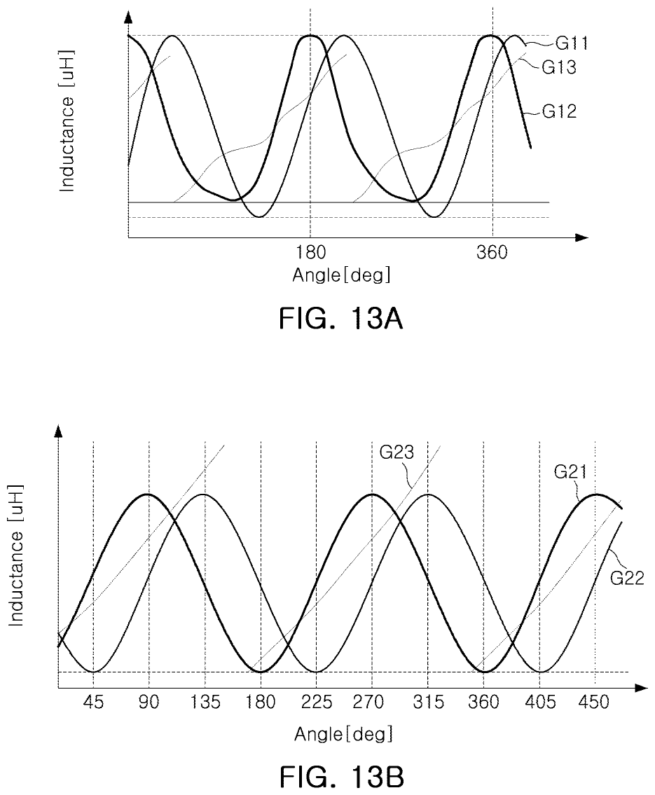

This will be further described with reference to FIGS. 13A and 13B.

FIG. 13A is a graph of an impedance change signal of the first and second sensors when the holder portion is not employed, and FIG. 13B is a graph of an impedance change signal of the first and second sensors when the holder portion is employed.

In FIG. 13A, G11 and G12 are graphs, respectively illustrating impedance change signals having sine and cosine function forms by the first and second sensors, and G13 is a linearity graph represented by an arc-tangent (arc-tan) function based on the impedance change signals of the first and second sensors.

In FIG. 13B, G21 and G22 are graphs, respectively illustrating impedance change signals having sine wave and cosine wave forms by the first and second sensors, and G23 is a linearity graph represented by an arc tangent (arc-tan) function based on the impedance change signals of the first and second sensors.

As can be seen from the linearity graph G13 of FIG. 13A and the linearity graph G23 of FIG. 13B, linearity may be improved in an apparatus for sensing a rotating body according to the various examples described herein in which a holder portion is employed.

As described above, in a structure for sensing a rotating body having a shaft and a digital crown, a structure for holding a sensor portion to reduce an assembly deviation may be provided to reduce a characteristic deviation caused by an assembly deviation of structures.

While specific examples have been illustrated and described above, it will be apparent after gaining an understanding of this disclosure that various changes in form and details may be made in these examples without departing from the spirit and scope of the claims and their equivalents. The examples described herein are to be considered in a descriptive sense only, and are not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for sensing a rotating body, the apparatus comprising:
a rotating body including a detection target portion;
a pattern portion disposed in the detection target portion in a direction in which the rotating body rotates;
a frame that rotatably supports the rotating body;
a first sensor disposed to oppose a first region of the detection target portion;
a second sensor spaced apart from the first sensor and disposed to oppose a second region of the detection target portion; and
a holder portion coupled to the frame to hold the first sensor and the second sensor.

2. The apparatus of claim 1, further comprising:
a substrate on which the first sensor and the second sensor are disposed, the substrate having a plurality of holes,
wherein the holder portion includes a plurality of projections configured to be inserted into and coupled to the plurality of holes of the substrate.

3. The apparatus of claim 2, wherein the frame comprises:
opposite side body portions, each of the opposite side body portions having a through-hole into which the rotating body is inserted; and
a plurality of legs disposed between the opposite side body portions in an axial direction of the rotating body in the vicinity of the rotating body inserted into the through-holes.

4. The apparatus of claim 3, wherein each of the opposite side body portions of the frame includes a plurality of projections configured to be coupled to the holder portion,
the holder portion includes a plurality of grooves disposed in positions, respectively corresponding to the plurality of projections of the opposite side body portions of the frame, and
the plurality of projections of the opposite side body portions of the frame are configured to be inserted into the plurality of grooves of the holder portion.

5. The apparatus of claim 3, wherein the holder portion includes a plurality of projections configured to be in contact with the opposite side body portions of the frame when the holder portion is coupled to the opposite side body portions of the frame,
each of the opposite side body portions includes a plurality of through-portions configured to be in contact with the holder portion, and
the plurality of projections of the holder portion are configured to be inserted into and coupled to the plurality of through-portions of the opposite side body portions of the frame.

6. The apparatus of claim 3, wherein the frame comprises a step disposed between a first portion, coupled to the substrate, and a second portion to which the holder portion is coupled.

7. The apparatus of claim 3, further comprising a coupling ring disposed between the through-hole of one of the opposite side body portions of the frame and the rotating body such that the rotating body is rotatably and closely coupled to the respective through-hole of the frame.

8. The apparatus of claim 3, wherein the substrate comprises a flexible printed circuit board (FPCB), and
the first sensor and the second sensor are disposed between the plurality of legs of the frame.

9. An apparatus for sensing a rotating body, the apparatus comprising:
a rotating body including a detection target portion;
a pattern portion disposed in the detection target portion in a direction in which the rotating body rotates, and having a single band shape surrounding the detection target portion;
a frame into which the rotating body is inserted;
a first sensor disposed to oppose a first region of the detection target portion;
a second sensor disposed to oppose a second region of the detection target portion and spaced apart from the first sensor to form an angle; and
a holder portion coupled to the frame to support the first sensor and the second sensor.

10. The apparatus of claim 9, further comprising:
a substrate on which the first sensor and the second sensor are disposed, the substrate having a plurality of holes,
wherein the holder portion includes a plurality of projections configured to be inserted into and coupled to the plurality of holes of the substrate.

11. The apparatus of claim 10, wherein the frame comprises:
opposite side body portions, each of the opposite side body portions having a through-hole into which the rotating body is inserted; and
a plurality of legs disposed between the opposite side body portions in an axial direction of the rotating body in the vicinity of the rotating body inserted into the through-holes.

12. The apparatus of claim 11, wherein each of the opposite side body portions of the frame includes a plurality of projections configured to be coupled to the holder portion,
the holder portion includes a plurality of grooves disposed in positions, respectively corresponding to the plurality of projections of the opposite side body portions of the frame, and
the plurality of projections of the opposite side body portions of the frame are configured to be inserted into the plurality of grooves of the holder portion.

13. The apparatus of claim 11, wherein the holder portion includes a plurality of projections configured to be in contact with the opposite side body portions of the frame when the holder portion is coupled to the opposite side body portions of the frame,
each of the opposite side body portions includes a plurality of through-portions configured to be in contact with the holder portion, and
the plurality of projections of the holder portion are configured to be inserted into and coupled to the plurality of through-portions of the opposite side body portions of the frame.

14. The apparatus of claim 11, wherein the frame comprises a step disposed between a first portion, coupled to the substrate, and a second portion to which the holder portion is coupled.

15. The apparatus of claim 11, further comprising a coupling ring disposed between the through-hole of one of the opposite side body portions of the frame and the rotating body such that the rotating body is rotatably and closely coupled to the respective through-hole of the frame.

16. The apparatus of claim 11, wherein the substrate comprises a flexible printed circuit board (FPCB), and
the first sensor and the second sensor are disposed between the plurality of legs of the frame.
